(19) United States
(12) Patent Application Publication
(10) Pub. No.: US 2023/0267113 A1
(43) Pub. Date: Aug. 24, 2023

(54) DCF CONFIDENCE SCORE AGING

(71) Applicant: Dell Products L.P., Round Rock, TX (US)

(72) Inventors: Nicole Reineke, Northborough, MA (US); Stephen J. Todd, North Andover, MA (US); Trevor Scott Conn, Leander, TX (US)

(21) Appl. No.: 17/652,197

(22) Filed: Feb. 23, 2022

(51) Int. Cl. G06F 16/23

(52) U.S. Cl. CPC G06F 16/2365

(57) ABSTRACT

One example method includes annotating data with confidence information as the data transits a data confidence fabric, after the data has transited a portion of the data confidence fabric, using the confidence information to generate a data confidence score, assigning the data confidence score to the data, and adjusting the data confidence score. In some cases, the data confidence score may be automatically adjusted downward over time and/or may be adjusted based on input concerning the data.

### FIELD OF THE INVENTION

Embodiments of the present invention generally relate to data confidence scores such as may be generated in a data confidence fabric. More particularly, at least some embodiments of the invention relate to systems, hardware, software, computer-readable media, and methods for assessing a data confidence score as the data confidence score ages.

### BACKGROUND

A data confidence fabric enables the appending of metadata to data as that data is generated and travels through the data confidence fabric to be used, ultimately, by an application that needs the data. The metadata may include trust insertion metadata that, in general, reflect the extent to which various data handling components in the data confidence fabric are assessed as being trustworthy or not. This metadata may be inserted by any or all of the components that handle the data as the data travels through the data confidence fabric. After the data has transited the data confidence fabric, an overall data confidence score may be calculated, based on the metadata that was annotated to the data, and the score then assigned to the data. Thus, the data confidence score constitutes an assessment of the data at a particular point in time, or within a constrained time frame. However, there is presently no known mechanism for assessing the data confidence score as the data confidence score ages over time.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example data confidence fabric (DCF).

FIG. 2 discloses aspects of an example architecture according to some embodiments.

FIG. 3 discloses an example method for data confidence score adjustment.

FIG. 4 discloses aspects of an example computing entity operable to perform any of the claimed methods, processes, and operations.

### DETAILED DESCRIPTION OF SOME EXAMPLE EMBODIMENTS

Embodiments of the present invention generally relate to data confidence scores such as may be generated in a data confidence fabric. More particularly, at least some embodiments of the invention relate to systems, hardware, software, computer-readable media, and methods for assessing a data confidence score as the data confidence score ages.

In general, example embodiments of the invention may operate to obtain information indicating how various selectable data parameters, such as accuracy and trustworthiness of the data for example, may have changed since the time that a data confidence score was assigned to that data. This information may comprise, for example, user feedback concerning the data.

Depending upon the outcome of the assessment of the data parameters, the initially assigned data confidence score may, or may not, be adjusted. For example, if the accuracy and trustworthiness of a piece of data has come into question, the data confidence score for that data may thus be reduced and, correspondingly, the value of that data to a user may decrease. That is, in general, a user may, but does not necessarily, place greater value on data that has a relatively high confidence score, and somewhat lesser value on data that has a relatively lower data confidence score. One or more thresholds may be defined that delineate what does, or does not, constitute an acceptable data confidence score.

Other mechanisms may additionally, or alternatively, be used to implement adjustments, either up or down, to a data confidence score. For example, a constant value may be defined in the context of a particular use case and used to recalculate data confidence as the associated data ages.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment of the invention may enable the confidence and, thus, the value and utility, of data to be assessed over time. An embodiment may enable adjustments to data confidence based on changing circumstances and/or user input. An embodiment may enable a user to obtain current information concerning the state of confidence in particular data. Various other advantageous aspects of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Example Operating Environment

The following is a discussion of aspects of example operating environments for various embodiments of the invention. This discussion is not intended to limit the scope of the invention, or the applicability of the embodiments, in any way.

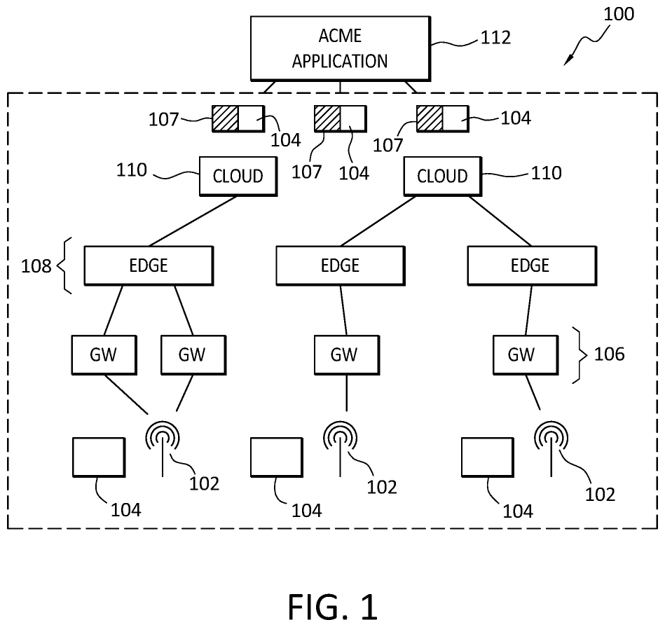

With reference now to FIG. 1, some contextual and other information is provided concerning some example embodiments. In particular, FIG. 1 discloses a DCF 100 for a fictional company ‘ACME.’ The example DCF 100 may include one or more devices 102, such as IoT devices for example, that may be operable to collect and transmit data 104. The data from the devices 102 may be transmitted to a first level of the DCF that comprises one or more gateways 106. As shown, data 104 may be transmitted to multiple gateways 106. One or more of the gateways 106 may associate trust metadata 107 with the received data 104 in such a way that a relationship is established, and captured in some way, between the trust metadata 107 and the data 104. Association of the trust metadata 107 with the data 104 may be accomplished in various ways, including by appending the trust metadata to the data, or storing the trust metadata, such as in a ledger for example, in a way that associates the trust metadata 107 with the data 104. In this latter example, the trust metadata 107 may be stored separately from the data 104.

In the illustrative case of FIG. 1, the gateway 106 may then then pass the data 104, and possibly the trust metadata 107, to one or more edge devices 108 that collectively define a second level of the DCF 100. Alternatively, and as noted earlier, the trust metadata 107 may be associated with the data 104 in a way that does not necessarily involve appending the trust metadata 107 to the data 104.

One or more of the edge devices 108 may, in turn, insert additional trust metadata to create updated trust metadata 107 and then pass the data 104 and trust metadata 107 to a cloud environment such as a cloud computing site 110, from where an application 112 performing an application workload may access the data 104 and the trust metadata 107.

Thus, in FIG. 1, the raw device data 104 may flow through multiple levels of a generic hardware environment that has various levels of processing, memory, and storage capabilities. As the data 104 flows through the levels, DCF software running on each node may add provenance and trust metadata/scoring, collectively, the trust metadata 107, to the data 104. The application 112 may access the trust metadata 107 and use the trust metadata as a basis to measure and/or otherwise evaluate the trustworthiness of the data 104.

It is noted that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### B. Aspects of An Example Architecture

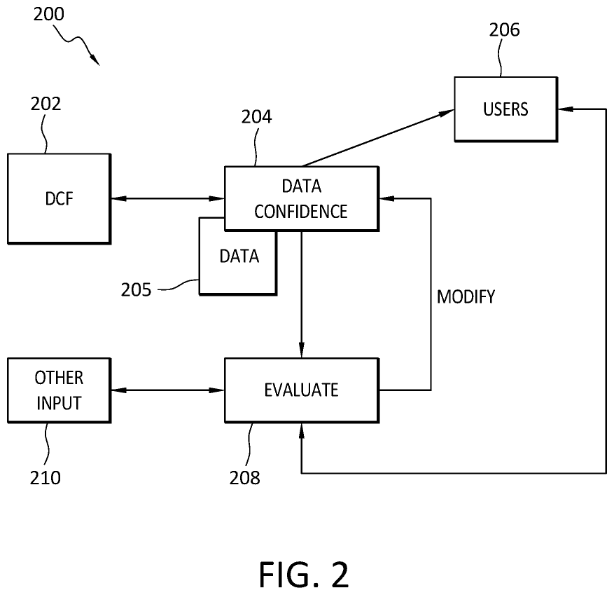

With reference now to FIG. 2, details are provided concerning an example architecture 200 that may be employed in some embodiments. The example architecture 200 may include a DCF (Data Confidence Fabric) 202 (see also, DCF 100 in FIG. 1) that generates data confidence information 204, such as data confidence scores for example, associated with data 205 that may have been generated in the DCF 202. The data confidence scores 204 may be accessible by users 206, such as humans and applications for example.

From time to time, such as on its own initiative and/or as directed by a user 206, for example, an evaluation module and/or evaluation process and/or human, individually and collectively denoted as the evaluator 208, may access and evaluate both the data 205, and the associated data confidence information 204. Such evaluations may be based, for example, on user 206 input and/or other input 210. An example evaluation may consider any degradation, improvement, and/or other changes, in one or more data parameters, such as the accuracy and trustworthiness of the data, that have occurred over time. Note that such degradations may result not only in a change in confidence score, but also in a reduction, from the perspective of a user for example, in the value of the data. As well, an improvement in a data parameter may result at times. For example, a subsequent independent confirmation of the accuracy of data may result in an improvement of the trustworthiness of data and, thus, an increase in a confidence score associated with that data. Depending upon the outcome of the evaluation, the data confidence information 204 may, or may not, be modified. The modified data confidence information 204 may be pushed to, and/or pulled by, the users 206. In some instances, a user 206 may be notified by the evaluator 208 when a change has been made to the data confidence information 204.

For example, if the accuracy and trustworthiness of a piece of data 205 has come into question, the data confidence score 204 for that data 205 may thus be reduced by the evaluator 208 and, correspondingly, the value of that data 205 to a user 206 may decrease. That is, in general, a user may, but does not necessarily, place greater value on data that has a relatively high confidence score, and somewhat lesser value on data that has a relatively lower data confidence score. One or more thresholds may be defined that delineate what does, or does not, constitute an acceptable data confidence score.

Other mechanisms may additionally, or alternatively, be used to implement adjustments, either up or down, to a data confidence score. For example, a constant value may be defined in the context of a particular use case and used to recalculate data confidence on an ongoing basis as the associated data ages.

To illustrate with an example, the parameter ‘theta’ is used to represent a time value decline of the value of an options contract (e.g., in connection with financial markets). Theta may have a fixed value that represents a particular amount of time value decline per unit of time, such as $5/day. A similar approach may be used with respect to data confidence.

That is, the constant value may indicate a specified amount of decline in data confidence per unit of time. For example, the constant value may be 0.3/month so that, over a period of 10 months, the confidence score would decline by 3.0 (0.3×10). In some embodiments, the evaluator 208 may automatically downgrade a data confidence score 204 based on a constant, specified, value. Note that the decline in confidence need not necessarily be linear and could, for example, be logarithmic, geometric, or have some other form, as may be dictated by knowledge and experience. Further, the constant value may be changed over time.

In the foregoing example, it may be the case that data confidence has a tendency to decline over time, for example, as circumstances, context, and new knowledge and evaluation techniques come to light. However, that may not always be the case. In fact, in some instances, data confidence may remain the same as it was initially assigned, or even increase, for example, as knowledge is gained and evaluation techniques improve. Further, a data confidence score may be dropped to zero in a case where the data has reached a particular age, or where the data is replaced by other data.

An increase or decrease in data confidence may be a function of the environment in which the data was gathered. For example, data gathered in a static environment that changes only a little, or not at all, over time may retain its initial confidence level. On the other hand, the confidence in data gathered in a dynamic environment, such as a warfighting environment for example, may change rapidly, and possibly continuously, and unpredictably. In such cases, a data confidence score may be adjusted in real time as an event is occurring, or adjusted immediately after occurrence of the event.

### C. Data Confidence

As used herein, ‘data confidence’ embraces, but is not necessarily limited to, a relative confidence level with regard to one or more parameters of data. The following examples, are illustrative, but not limiting, of this concept.

In some instances, data confidence refers to a relative confidence level that particular data is accurate and/or complete, as of a particular time, or with respect to some particular standard. As another example, data confidence refers, in some instances, to a relative confidence level that particular data has not been compromised. Further, data confidence, in some instances, refers to a relative confidence level that particular data is not vulnerable to attack.

Further, it may not be necessary in every case that data confidence be high. More generally, the acceptable data confidence may be a function of the criticality, or lack thereof, of the data. For example, high data confidence may be required in a warfighting environment, but a lower level of data confidence may be acceptable in less consequential environments.

### D. Illustrative Examples of Data Confidence Score Adjustments

With further reference to an evaluation process directed to the data confidence information 204, the evaluator 208 may obtain information, from any of a variety of sources, indicating how one or more data 205 parameters, such as accuracy, trustworthiness to a user or application, and completeness, for example, of the data 205, may have changed since the time that a data confidence score 204 was generated and assigned to the data 205. This information may comprise, for example, user 206 feedback concerning the data 205.

As another illustration, if data confidence drops sharply in a given data path, that is, a path through a DCF or other environment traveled by the data, the dropoff may give rise to a question as to why the confidence level was so high in the first place. Thus, the dropoff may be used as an input to the confidence score generation methodology so that initial confidence scores may be tempered somewhat to reflect that the data path traveled by the data is problematic in some regard.

In some embodiments, a user or other entity may be able to access part, or all, of a history of changes to a data confidence score for particular data. This historical data confidence information may provide useful insights such as, but not limited to, how quickly data confidence changes, types of data that are relatively more/less prone to confidence changes, the magnitude of data confidence changes, when data confidence changes, and in response to what events/information, and how the data is used, if at all, after an event that caused a change to the data confidence.

Following are some illustrative examples of situations in which a change to a data confidence score may be implemented. These are provided by way of example, and not limitation.

### D.1 Example 1

Suppose that the user 206 runs an application that uses the data 205 as input, and the output of that application is identified as having problems that can be ascribed to the input data 205. The user 206 may provide feedback to the evaluator 208 indicating that the input data 205, with which data confidence information 204 is associated, is inaccurate and/or otherwise problematic.

### D.2 Example 2

As another example, some of the data 205 may have been generated by an algorithm that was later discovered to have a bug, thus rendering the data 205 inaccurate and/or incomplete at the time it was generated. Because the data confidence score 204 may have been assigned to the data 205 prior to discovery of the bug, the data confidence score 204 for the data 205 may need to be reduced due to discovery of the bug. This information may be provided as input 210 to the evaluator 208.

### D.3 Example 3

In a further example, the data 205 may, after having initially been assigned a data confidence score 204, be migrated to another environment that may not have the security controls of the environment where the data 205 was generated. Due to the less stringent security in the new environment of the data 205, it may be necessary to reduce the data confidence score 204 to reflect that the data 205 may be vulnerable to attack in its new environment. Thus, a data confidence score may be a function of a feature set, such as security for example, relating to data with which that data confidence score is associated.

### D.4 Example 4

In still another illustrative scenario, sensors in a battlefield environment may generate data concerning events taking place in that environment. While the confidence in the data may initially be high, the battlefield environment and its participants may be highly dynamic, such that data may quickly become outdated, and of little or no value. In this case, there may be a need to quickly reduce the confidence score to signal to prospective users that the data has become of questionable value in light of changes to the context in which that data was initially generated. By comparison, data concerning the geography of the battlefield environment may have a high confidence score, since the geography is unlikely to change, at least during the relevant time period.

### E. Example Use Case

As noted, example embodiments may operate to refine a perceived value of data, as well as to modify a confidence score that was assigned to that data. An example of the former is set forth below.

Suppose that an analyst in ABC Company's Office of the CTO is doing research on the latest innovations in quantum computing. She is requesting new information from Project XYZ with a data confidence score of 90% or higher. This score was produced by models that quantify past ingested data based on their source, reviewed content, and frequency of access, for example. After she is finished reviewing the material, the user is prompted to review this new information for its perceived value. This review process, she has been trained to understand, is necessary to continue providing high quality information to herself and her team in the future. Her review input will be used to refine the perceived value score, which may either remove the content from similar searches or retain it.

### F. Example Methods

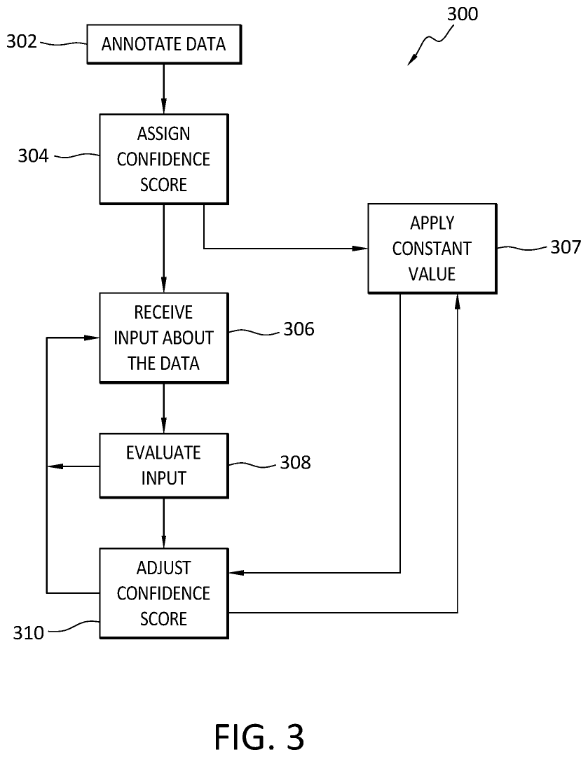

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method 300, which may be performed in whole or in part by an evaluator, is disclosed that may be used to assess, and modify if necessary, data confidence scores. The method 300 may begin at 302 where data is annotated with confidence information, which may comprise confidence metadata, as the data transits various elements of a DCF.

After the data has transited the DCF, or some specified portion(s) of the DCF, the confidence information in the annotations may be used to calculate a data confidence score. The data confidence score may then be assigned 304 to the data. At some point after assignment 304 of the data confidence score, the data confidence score may be assessed, and possibly adjusted, up or down, depending on the outcome of the assessment.

Particularly, at 306, input may be received that comprises information about the data to which the confidence score was assigned 304. Examples of such input are disclosed elsewhere herein. The input may be evaluated 308 and, depending upon the results of the evaluation 308, the confidence score 310 may be adjusted. For example, the confidence score may be increased at 310, or decreased at 310. In some cases, the evaluation 308 may reveal that no change to the confidence score is needed and, in such cases, the method may return from 308 to 306. In some cases, a data confidence score for data other than, or in addition to, the data to which the confidence score was assigned 304 may be adjusted. Such an adjustment may be made based, for example, on similarity of the datasets, and similarity of circumstances in which the two datasets were generated.

In some circumstances, the evaluation process 308 may be bypassed, and the confidence score 310 automatically adjusted by a set amount for each of ‘n’ time increments. Such adjustments may be increases or decreases in the confidence score, although decreases may be a more typical scenario.

With continued reference to FIG. 3, after a confidence score has been assigned 304 to data, a constant value may be applied 307 to increment, or decrement, that confidence score once, or multiple times. The constant value may be determined based, for example, on past experience with similar data/datasets as that to which the confidence score was initially assigned 304. For example, application 307 of a constant value of 0.1 each month for a period of 5 months, which may be specified by a data retention policy for example, would result in a decrease in the confidence score by a total of 0.5 over the 5 month period (0.1×5). In some embodiments, application 307 of the constant value may continue until the confidence score reaches an upper, or lower, threshold. In the latter case, the data may be deleted or made inaccessible, for example, once the confidence score has declined to a particular level.

It is noted that the example approaches to confidence score adjustments disclosed in FIG. 3 are not necessarily mutually exclusive. That is, a particular confidence score may be adjusted automatically, such as by application of a fixed value 307, and/or may be adjusted based on received input 306. For example, a data confidence score may, early in its life, be adjusted based on received input 306. If no further input is received for a certain period of time and/or no further input is expected for the data, application of the constant value 307 may automatically begin, and continue until a data confidence threshold score is reached, at which point some action may be taken with regard to the associated data, such as processing or deleting the data for example. In some embodiments, application of the constant value 307 may, at any time, be overridden based on receipt 306, and evaluation 308, of input.

### G. Further Example Embodiments

Following are some further example embodiments of the invention. These are presented only by way of example and are not intended to limit the scope of the invention in any way.

Embodiment 1. A method, comprising: annotating data with confidence information as the data transits a data confidence fabric; after the data has transited a portion of the data confidence fabric, using the confidence information to generate a data confidence score; assigning the data confidence score to the data; and adjusting the data confidence score.

Embodiment 2. The method as recited in embodiment 1, wherein the data confidence score is adjusted using a fixed value

Embodiment 3. The method as recited in any of embodiments 1-2, wherein the data confidence score is decreased using the fixed value.

Embodiment 4. The method as recited in any of embodiments 1-3, further comprising receiving input related to a data parameter of the data, and adjusting the data confidence score based on an evaluation of the input.

Embodiment 5. The method as recited in embodiment 4, wherein the data confidence score is decreased based on the evaluation of the input.

Embodiment 6. The method as recited in any of embodiments 1-5, wherein the data is generated by an Internet of Things device.

Embodiment 7. The method as recited in any of embodiments 1-6, further comprising processing the data after the data confidence score has reached a specified value.

Embodiment 8. The method as recited in any of embodiments 1-7, wherein a relative value of the data is a function of the data confidence score.

Embodiment 9. The method as recited in any of embodiments 1-8, wherein the data confidence score is adjusted based on input received from a user of the data.

Embodiment 10. The method as recited in any of embodiments 1-9, wherein the data confidence score is adjusted in real time as, or immediately after, an event occurs in an environment in which the data was collected.

Embodiment 11. A system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

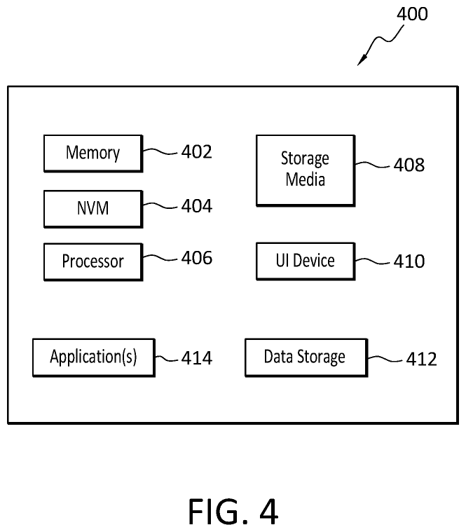

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
annotating data with confidence information as the data transits a data confidence fabric;
after the data has transited a portion of the data confidence fabric, using the confidence information to generate a data confidence score;
assigning the data confidence score to the data; and
adjusting the data confidence score.

2. The method as recited in claim 1, wherein the data confidence score is adjusted using a fixed value.

3. The method as recited in claim 1, wherein the data confidence score is decreased using the fixed value.

4. The method as recited in claim 1, further comprising receiving input related to a data parameter of the data, and adjusting the data confidence score based on an evaluation of the input.

5. The method as recited in claim 4, wherein the data confidence score is decreased based on the evaluation of the input.

6. The method as recited in claim 1, wherein the data is generated by an Internet of Things device.

7. The method as recited in claim 1, further comprising processing the data after the data confidence score has reached a specified value.

8. The method as recited in claim 1, wherein a relative value of the data is a function of the data confidence score.

9. The method as recited in claim 1, wherein the data confidence score is adjusted based on input received from a user of the data.

10. The method as recited in claim 1, wherein the data confidence score is adjusted in real time as, or immediately after, an event occurs in an environment in which the data was collected.

11. A non-transitory storage medium having stored therein instructions that are executable by one or more hardware processors to perform operations comprising:
annotating data with confidence information as the data transits a data confidence fabric;
after the data has transited a portion of the data confidence fabric, using the confidence information to generate a data confidence score;
assigning the data confidence score to the data; and
adjusting the data confidence score.

12. The non-transitory storage medium as recited in claim 11, wherein the data confidence score is adjusted using a fixed value

13. The non-transitory storage medium as recited in claim 11, wherein the data confidence score is decreased using the fixed value.

14. The non-transitory storage medium as recited in claim 11, wherein the operations further comprise receiving input related to a data parameter of the data, and adjusting the data confidence score based on an evaluation of the input.

15. The non-transitory storage medium as recited in claim 14, wherein the data confidence score is decreased based on the evaluation of the input.

16. The non-transitory storage medium as recited in claim 11, wherein the data is generated by an Internet of Things device.

17. The non-transitory storage medium as recited in claim 11, wherein the operations further comprise processing the data after the data confidence score has reached a specified value.

18. The non-transitory storage medium as recited in claim 11, wherein a relative value of the data is a function of the data confidence score.

19. The non-transitory storage medium as recited in claim 11, wherein the data confidence score is adjusted based on input received from a user of the data.

20. The non-transitory storage medium as recited in claim 11, wherein the data confidence score is adjusted in real time as, or immediately after, an event occurs in an environment in which the data was collected.
